(19) United States
(12) Patent Application Publication
(10) Pub. No.: US 2026/0253927 A1
(43) Pub. Date: Aug. 27, 2026

(54) DIAGNOSTIC METHOD FOR A FUEL CELL SYSTEM, AND A FUEL CELL SYSTEM

(71) Applicant: Robert Bosch GmbH, Stuttgart (DE)

(72) Inventor: Matthias Rink, Herrenberg (DE)

(21) Appl. No.: 18/877,441

(22) PCT Filed: Jun. 22, 2023
(86) PCT No.: PCT/EP2023/066908

§ 371 Date: Dec. 20, 2024

(30) Foreign Application Priority Data
Jun. 22, 2022 (DE) 10 2022 206 216.7

(51) Int. Cl. H01M 8/04303; H01M 8/04537

(52) U.S. Cl. CPC H01M 8/04303; H01M 8/04552

(57) ABSTRACT

The invention presented relates to a diagnostic method (100) for diagnosing a status of a fuel cell of a fuel cell system (200),

wherein the diagnostic method (100) comprises:
initiating (101) a shutdown operation of the fuel cell system (200) by closing cathode shut off valves of the fuel cell system (200) and setting a predetermined power requirement curve on the fuel cell system (200) according to a predetermined power requirement,
determining (103) a voltage curve and/or a current curve of at least one fuel cell of the fuel cell system (200) during a power output according to the power requirement,
comparing (105) the determined voltage curve and/or the determined current curve with a predetermined reference curve,
outputting (107) a warning message in the event that the determined voltage curve (301) and/or the determined current curve (307) differs from the reference curve (303) at least in regions by a value that is above a predetermined diagnostic threshold (305).

### BACKGROUND

The present invention relates to a diagnostic method for a fuel cell system, and a fuel call system.

Fuel cell systems convert chemical energy into electrical energy or electrical energy into chemical energy. The fuel cells used to do so wear out or age over the course of their service lives. In particular, the catalytic activity decreases as the age of a fuel cell increases.

### SUMMARY

Presented in the context of the invention presented are a diagnostic process and a fuel cell system. In this context, features and details described in connection with the diagnostic method according to the invention clearly also apply in connection with the fuel cell system according to the invention, and respectively vice versa, so that mutual reference to the individual considerations of the invention always is or can be made with respect to the disclosure.

The present invention serves in particular to determine a status of a fuel cell system.

Therefore, according to a first consideration of the present invention, a diagnostic method for diagnosing the status of a fuel cell of a fuel cell system is presented.

The diagnostic method comprises initiating a shutdown operation of the fuel cell system by closing cathode shut off valves of the fuel cell system and setting a predetermined power requirement curve on the fuel cell system, as well as determining a voltage curve and/or a current curve of at least one fuel cell of the fuel cell system during a power output according to the power requirement, comparing the determined voltage curve and/or the determined current curve with a predetermined reference curve and issuing a warning message if the determined voltage curve and/or the determined current curve differs from the reference curve at least in some ranges by a value which is above a predetermined diagnostic threshold.

The invention presented is based on the principle that a shutdown operation of a fuel cell system in which a so-called “bleed down”, i.e., controlling the fuel cell system with a predetermined power requirement to consume a residual oxygen in a fuel cell stack of the fuel cell system, is used to infer a status of the respective fuel cells of the fuel cell stack. To this end, a behavior of the fuel cells during the shutdown procedure is determined using a voltage sensor and/or a current sensor. The measured values determined thereby or a corresponding voltage curve and/or current curve are compared with a predetermined reference curve, so that a warning message can be output if the determined voltage curve and/or determined current curve differs at least in some ranges from the reference curve by a value that is above a predetermined diagnostic threshold. This warning message may be provided to a user of the fuel cell system to inform the user of a critical status of the fuel cell system, and/or it may be transmitted to a server to schedule maintenance, and/or it may be transmitted to a computing unit to activate a predetermined countermeasure, such as a repair function of the fuel cell system that undoes reversible aging effects.

It may be contemplated that the warning message will be output if the determined voltage curve has a range of increasing voltage after a range of continuously decreasing voltage.

A range of increasing voltage after a range of decreasing voltage is also referred to as “rebound” and is characteristic of fuel cells with reduced catalytic activity, as such fuel cells do not immediately convert the respective available oxygen, such that a residual amount of oxygen accumulates, allowing the voltage at the end of the power requirement to increase more than what was provided according to the power requirement.

It may further be contemplated that the diagnostic threshold comprises a first value at a first time and a second value at a second time, wherein the warning message is then output when measured values of the determined voltage curve at the first time are below the first value and at the second time are above the second value.

A rebound can be mapped easily and in a computationally effective manner using two threshold values, wherein a first threshold value indicates an upper threshold and the second threshold value indicates a lower threshold such that a rebound can be assumed if the first threshold is not met and the second threshold is exceeded. Depending on the amount of the first or second threshold value, a minimum rebound can be tolerated without a warning message.

It may furthermore be contemplated that the diagnostic method further comprises an activation step in which a program of the fuel cell system is activated that counteracts aging effects when the warning message is output.

A program that counteracts aging effects may be, for example, a maintenance program in which the fuel cell system is only purged with hydrogen to remove oxygen build-up.

It may further be contemplated that the warning message includes a metric quantifying a status of the fuel cell system, wherein the metric is determined as a function of a deviation between the determined voltage curve and/or current curve and the diagnostic threshold.

A metric that can quantify a state of the fuel cell system can, for example, be used to observe a change in the fuel cell system over time, i.e., during various shutdown operations, such that, for example, a time for maintenance may be interpolated and predicted accordingly for the future.

It may further be provided that the determined voltage curve comprises an incline over at least a range of the voltage curve and/or the determined current curve comprises an incline over at least a range of the current curve.

An incline indicates a change in the voltage curve or the current curve in a computationally effective manner, so that a change in the incline can be used as an indicator of a change in a status of a respective fuel cell.

It may further be provided that the metric is increased as the slope of the determined voltage curve and/or the slope of the determined current curve decreases.

As a decreasing incline indicates a less active or an aged fuel cell, this status may be mapped by increasing the metric.

It may further be provided that the incline is determined by means of deriving the range of the voltage curve and/or by means of deriving the range of the current curve.

By means of the derivation, a voltage behavior or a current behavior of a fuel cell can be evaluated across an entire predetermined range in a computationally efficient manner. Accordingly, any range may be selected and evaluated in full.

It may further be contemplated that the warning message is transmitted to a server via a wireless interface.

The respective determined data or warning messages may be transmitted to a server by means of a wireless interface, for example a WLAN interface or a mobile telephone interface. For example, the server may be a central database that automatically schedules and manages maintenance of the fuel cell system in response to data transmitted by the fuel cell system.

According to a second aspect, the presented invention relates to a fuel cell system. The fuel cell system comprises a computing unit configured to perform one possible embodiment of the presented diagnostic method.

Further advantages, features, and details of the invention arise from the following description, in which exemplary embodiments of the invention are described in detail with reference to the drawings. In this context, the features mentioned in the claims and in the description can each be essential to the invention individually or in any combination.

### BRIEF DESCRIPTION OF THE DRAWINGS

Shown are:

FIG. 1 one possible embodiment of the diagnostic method presented,

FIG. 2 a schematic representation of one possible embodiment of the presented fuel cell system,

FIG. 3 a voltage curve of a fuel cell of the fuel cell system according to FIG. 2.

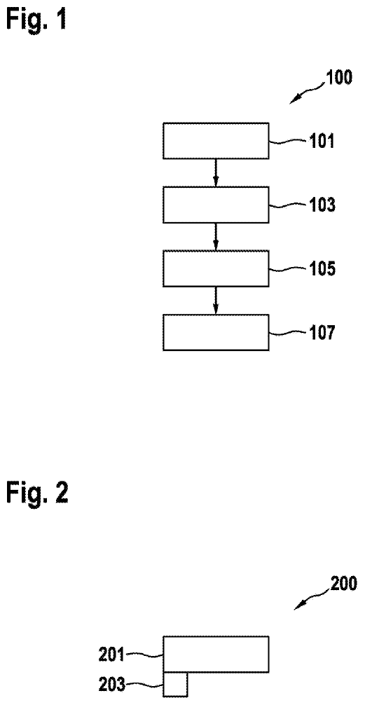

FIG. 1 shows a diagnostic method 100 for diagnosing a status of a fuel cell system.

### DETAILED DESCRIPTION

The diagnostic method 100 comprises an initiation step 101 in which a shutdown operation of the fuel cell system is initiated by closing cathode shut off valves of the fuel cell system and a predetermined power requirement curve is set on the fuel cell system according to a predetermined power requirement.

Further, the diagnostic method 100 comprises a determination step 103 in which a voltage curve and/or a current curve of at least one fuel cell of the fuel cell system is determined during a power output according to the power requirement.

Further, the diagnostic method 100 comprises a comparison step 105 in which the determined voltage curve and/or the determined current curve is compared with a predetermined reference curve.

Further, the diagnostic method 100 comprises an output step 107 in which a warning message is issued in the event that the determined voltage curve and/or current curve differs from the reference curve at least in regions by a value that is above a predetermined diagnostic threshold.

FIG. 2 shows a fuel cell system 200. The fuel cell system 200 comprises a computing unit 201 configured to perform the diagnostic method 100.

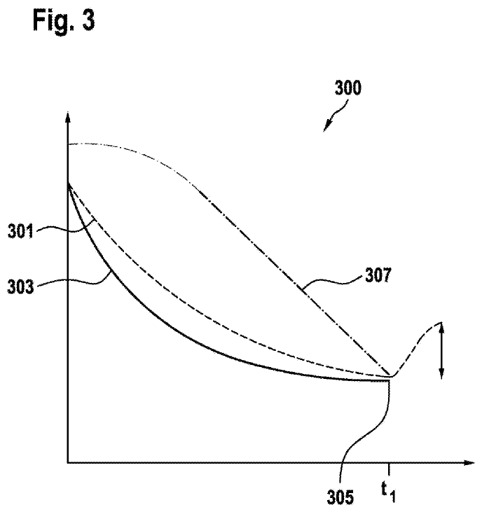

FIG. 3 shows a diagram 300. The X axis of the diagram 300 extends over time, for example in [s] and the Y axis extends over a voltage in [V] and/or a current in [A].

A curve 301 indicates a voltage curve of an aged fuel cell.

A curve 303 indicates a predetermined reference curve.

A diagnostic threshold 305 here is 5V, for example. Because the curve 301 completes a rebound at time t1 and differs from the curve 303 by a value that is above the diagnostic threshold 305, the fuel cell may be recognized as aged and a corresponding warning message may be output.

A curve 307 indicates a current curve of the fuel cell. In the present case, the current curve assumes the value “0” at time t1.

1. A diagnostic method (100) for diagnosing a status of a fuel cell of a fuel cell system (200),
wherein the diagnostic method (100) comprises:
initiating (101) a shutdown operation of the fuel cell system (200) by closing cathode shut off valves of the fuel cell system (200) and setting a predetermined power requirement curve on the fuel cell system (200) according to a predetermined power requirement,
determining (103) a voltage curve and/or a current curve of at least one fuel cell of the fuel cell system (200) during a power output according to the power requirement,
comparing (105) the determined voltage curve and/or the determined current curve with a predetermined reference curve,
outputting (107) a warning message in the event that the determined voltage curve (301) and/or the determined current curve (307) differs from the reference curve (303) at least in regions by a value that is above a predetermined diagnostic threshold (305).

2. The diagnostic method (100) according to claim 1, wherein
the warning message is output when the determined voltage curve (301) has a range of increasing voltage after a range of continuously decreasing voltage.

3. The diagnostic method (100) according to claim 1,
wherein
the diagnostic threshold (305) comprises a first value at a first time and a second value at a second time, wherein the warning message is output when measured values of the determined voltage curve (301) are below the first value at the first time and above the second value at the second time.

4. The diagnostic method (100) according to claim 1, wherein
the diagnostic method (100) further comprises an activation step in which a program of the fuel cell system (200) is activated that counteracts aging effects when the warning message is output.

5. The diagnostic method (100) according to claim 1,
wherein
the warning message comprises a metric quantifying a status of the fuel cell system (200), wherein the metric is determined as a function of a deviation between the determined voltage curve (301) and/or the determined current curve (307) and the diagnostic threshold (305).

6. The diagnostic method (100) according to claim 1, wherein
the determined voltage curve (301) comprises an incline over at least a range of the voltage curve (301) and/or the determined current curve (307) comprises an incline over at least a range of the current curve (307).

7. The diagnostic method (100) according to claim 5,
wherein
the metric is increased as the incline of the determined voltage curve (301) and/or the incline of the determined current curve (307) decreases.

8. The diagnostic method (100) according to claim 6,
wherein
the incline is determined by deriving the range of the voltage curve (301) and/or by means of deriving the range of the current curve (307).

9. The diagnostic method (100) according to claim 1,
wherein
the warning message is transmitted to a server via a wireless interface.

10. A fuel cell system (200) for converting energy, wherein the fuel cell system (200) comprises a computing unit (201) configured to perform a diagnostic method (100) according to claim 1.
